(19) United States
(12) Patent Application Publication
(10) Pub. No.: US 2005/0055556 A1
(43) Pub. Date: Mar. 10, 2005

(54) Policy enforcement

(76) Inventors: Simon Shiu, Bristol (GB); Adrian Baldwin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/871,662

(22) Filed: Jun. 18, 2004

(30) Foreign Application Priority Data
Jun. 19, 2003 (GB) 0314206.4

(51) Int. Cl. H04K 1/00

(52) U.S. Cl. 713/182

(57) ABSTRACT

A method of applying policy enforcement in a computing system comprises applying an authorisation policy within a secure hardware domain; and applying a digital signature within a secure hardware domain.

### FIELD OF THE INVENTION

The present invention relates to policy enforcement in computing systems.

### BACKGROUND TO THE INVENTION

The concept of using a secure hardware device to sign data for the purpose of guaranteeing its integrity is known. For example in http://www.sans.org/encryption/hardware SCC.PHP, there is described how hardware security modules can form a MAC of data and verify the MAC each time a request for data is made.

Known signatures are a more expensive way of achieving a similar level of integrity, except that a requestor can use a corresponding public key to check the integrity. However a problem with this approach is that the process requesting the signature needs to be trusted as does the underlying system and associated user accounts, for example root accounts. Where a server serving this information can be compromised, for example by a Trojan or where the administrator is not sufficiently trustable, then they can change the data and gain access to the hardware security module to gain the appropriate integrity check data, whether based on a MAC or on a signature.

It is known to use a signing key to communicate and guarantee the integrity of data. Such keys are also expected to be stored and used within a secure hardware device.

Referring to FIG. 1 herein, a known server computer entity 100 stores data 101. A client computer entity requests retrieval of an item of data from the server 100, in order to use that data for a purpose. The client computer entity 102 relies upon the server computer entity, and the processes operated by the server computer entity to guarantee the integrity and correctness of the data.

One way of indicating the integrity and correctness of the data, is for the server computer entity 100 to apply a digital signature 104 to the data, or a message such as a MAC to the data, so that the client computer entity can trust the data.

Referring to FIG. 2 herein, the known signature process 104 may operate such that when data is received by a server computer in process 200 the data is signed with a private key in process 201. Signature may be by a known PKI signature system as is known in the art. There is a certificate associated with the private key used to do the signing. The server receives a client request in process 202, and sends the signed data to the client in process 203. The client checks the signature in process 204, and thereby confirms that the client has obtained a correct data from the server.

Referring to FIGS. 3 and 4 herein, there is illustrated schematically a known extension of the process described with reference to FIGS. 1 and 2 herein, in which client 300 accesses data 301 in server computer entity 302 and attempts to change the data. The signature process 303 operates to receive a request to change the data in process 400. On receiving the request to change data, the signature process 303 proceeds to authenticate the entity making a request to change the data in process 401. Provided that the client entity 300 is authenticated by the signature process 303, then in process 402, the data is signed by the server.

The client computer entity 300 relies upon the signature process 303 to control the integrity of the data. The server controls the signing process, thereby gaining control of the integrity of the data, which constitutes a limit on the scope of controlling the integrity of the data.

In prior art systems, the security of the signature process relies upon the private key used to apply the signature. To increase security, digital keys may be stored in a secure hardware module 304 which keeps the private key safe from tampering. Such modules are available which hold digital keys securely, without being available outside the secure hardware module, and which will perform signature within the secure hardware module using encryption algorithms. Use of the secure hardware module increases the clients ability to trust the signature, since the operator of the client computer entity knows that if a signature has been applied, then it must have been applied by a secure hardware module.

One of the potential weaknesses of the system shown in FIGS. 3 and 4 is that the secure hardware module relies upon the process to be operating correctly. That is, the secure hardware module relies upon the integrity of the process itself, and the process which authenticates the clients computer is outside the secure hardware module, and therefore potentially open to being tampered with.

However, if a third party subverts the process, they can bypass the authentication process 303 completely.

In the prior art systems, authentication processes and policy enforcement processes are carried out in a relatively non-secure domain, separate to a secure domain in which signatures are applied.

Referring to FIG. 5 herein, there is illustrated schematically a known set of logical computing entities, in which a plurality of client computers 500-502 make a relatively large number of requests for access to data to a server computer 503, and in which changes to the data in the server 503 are relatively infrequent compared with the frequency of requests to access data. The client computer entities rely upon the integrity of the data stored within the server computer entity to a high degree. Typically, this situation occurs where there is data arranged according to a directory structure, which is accessed by a relatively large number of client computers, and making sure that the data is correct, as integrity, and is un-corrupted, is a paramount consideration.

This is in contrast to a situation such as a database, where the number of changes to data is relatively high, compared to the number of requests for access to data by client computers.

An example of a system which has a large number of requests for data, but where the data change relatively infrequently, is the Lightweight Directory Access Protocol (LDAP). In this protocol, there is a large directory, which has a lot of structure, where the structure is changed infrequently, but the structure is used to satisfy client data requests relatively frequently.

Another example is one of policy distribution by a server. In this example, if the client computers 500-502 need to enforce a policy, for example a security policy, then the security policies may be centralised in a server computer 503, and be frequently accessed by a plurality of client computer entities. The security policies may be altered from time to time by a set of administrators, but the frequency of alterations of the policy data are relatively infrequent compared to the frequency of requests to access the policy data by the plurality of client computers. Every time a client computer boots up, or reconfigures, they may need to access a security policy stored on the server computer. The client computer may need to check the signature on the security policy, to ensure that the correct security policy has been obtained.

In such prior art computer systems storing high integrity data and having multiple users, a conventional approach is to rely on one or more human administrators to enforce access control policies to data, and so practically security is not fully automated, but relies upon human monitoring.

### SUMMARY OF THE INVENTION

According to a first aspect of the present invention, there is provided a method of applying policy enforcement in a computing system, said method comprising:
applying an authorisation policy within a secure hardware domain; and
applying a digital signature within said secure hardware domain.

According to a second aspect of the present invention, there is provided a secure hardware device comprising:
a digital signature component for applying a digital signature to an item of data; and
a policy enforcement component for applying an access control policy to said item of data.

According to a third aspect of the present invention, there is provided a computer system comprising:
a server computer having a data storage device, which stores data in a file system;
a control component capable of controlling access to said file system; and
a secure hardware device, said secure hardware device configured for controlling changes to said file system made by at least one administrator person via said control component.

According to a fourth aspect of the present invention, there is provided a method of controlling changes to a file system, comprising:
receiving a request for making a change to said file system;
receiving a set of credentials of a person making said request to change said file system;
authenticating said credentials of said person, in a secure hardware device;
verifying that said request to change said file system conforms with a management policy for managing said file system; and
if said request conforms with said management policy, and said person is authenticated, then allowing said person to change said file system.

According to a fifth aspect of the present invention, there is provided a secure hardware device, comprising:
a tamper proof casing; and
a policy component, capable of storing a set of policies;
wherein said policy component is accessible by at least one person, who is authorized to change said policies; and
said set of policies control access to data stored externally of said secure hardware device.

According to a sixth aspect of the present invention, there is provided a system of computer entities configured into a plurality of domains comprising:
a client domain in which client users can access data;
a first level domain in which users of said first level domain have permission to modify said data; and
a second level domain in which users of said second level domain are permitted to set policies concerning the modification of data applicable in said first level domain.

According to a seventh aspect of the present invention, there is provided a method of operation of a system of computer entities, said method comprising:
organising said system of computer entities into;
a client domain in which client users can access data;
a first level domain in which users of said first level domain have permission to modify said data; and
a second level domain in which users of said second level domain are permitted to set policies concerning the modification of data carried out in said first level domain.

Other aspects of the invention are as recited in the claims herein.

Specific embodiments disclosed herein provide that a policy check and enforcement is tightly bound to a signing key within a secure hardware device. A secure hardware device can be configured to allow a different set of users, administrators, outsourcers or managers or a mixture of like persons to control changes to policies.

Remote parties may have an ability to identify a signing service and a binding service remotely, and therefore have remote management of policies.

Specific embodiments disclosed herein may move the computation which judges whether a user or a process has a right to change an item of data in to the same secure hardware device that is guarding cryptographic keys used to sign, and thus demonstrate the integrity of, the data. Physically incorporating computation in to a same secure hardware device which guards cryptographic keys may provide enhanced security, since such processes are likely to be attempted to be compromised by external attack. It also allows a different set of people or users to be responsible for managing changes to data, for example administrators rather than users, or managers rather than administrators.

Tamper resistant hardware has an advantage that a computation can be done locally, and yet still be trusted and managed by remote personnel.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a known client-server oriented computer system in which data stored on a server is signed;

FIG. 2 illustrates schematically operation of the computer system of FIG. 1 in which signatures of data are checked by a client computer;

FIG. 3 illustrates schematically a known client—server computer system in which a client may change data within a server, subject to authentication of the client by a signature process where digital keys are held by a secure hardware device;

FIG. 4 illustrates schematically one example of a known operation of the system of FIG. 3;

FIG. 5 illustrates schematically a known computer system in which a plurality of clients make frequent requests for data from a server computer;

FIG. 6 illustrates schematically a first computer system according to a first specific embodiment of the present invention;

FIG. 7 illustrates schematically components of a secure hardware device according to the first specific embodiment;

FIGS. 8a and 8b illustrate schematically operation of the computing system of FIG. 6, in which a first level administrator requests to change data within a directory;

FIG. 9 illustrates schematically a domain view of the computer system of FIG. 6;

FIG. 10 illustrates schematically the computer system according to the first specific embodiment of the present invention;

FIG. 11 illustrates schematically an example of operation of a second computer system according to a second specific embodiment of the present invention; and

FIG. 12 illustrates schematically a trusted domain view of a plurality of server computers as described with reference to FIG. 11 herein.

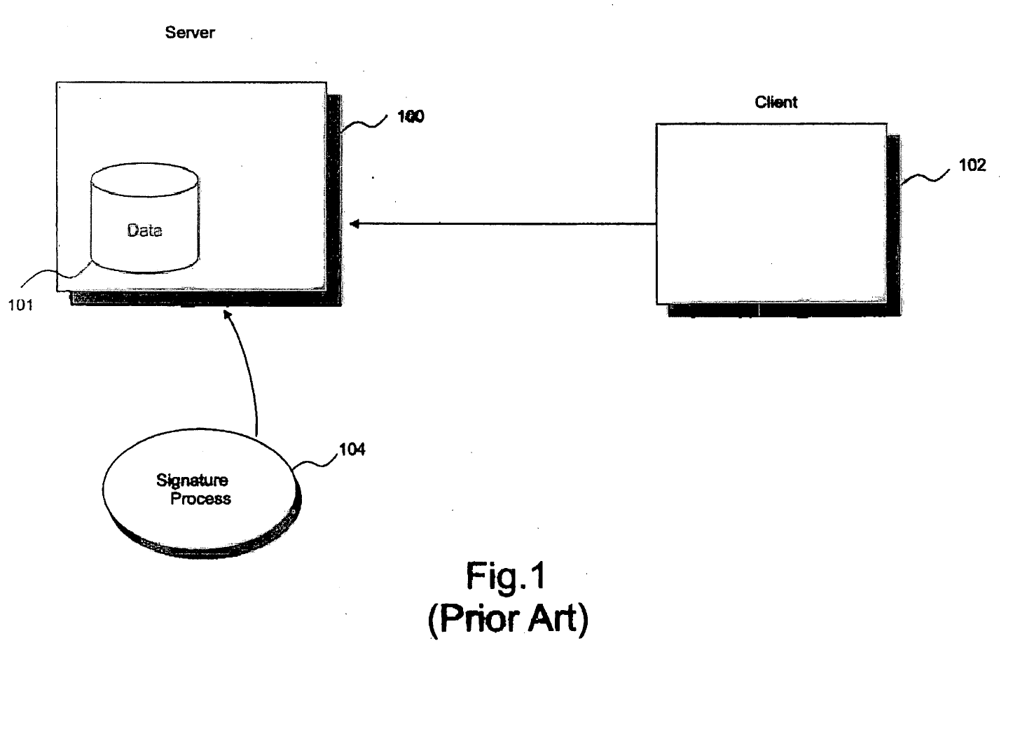

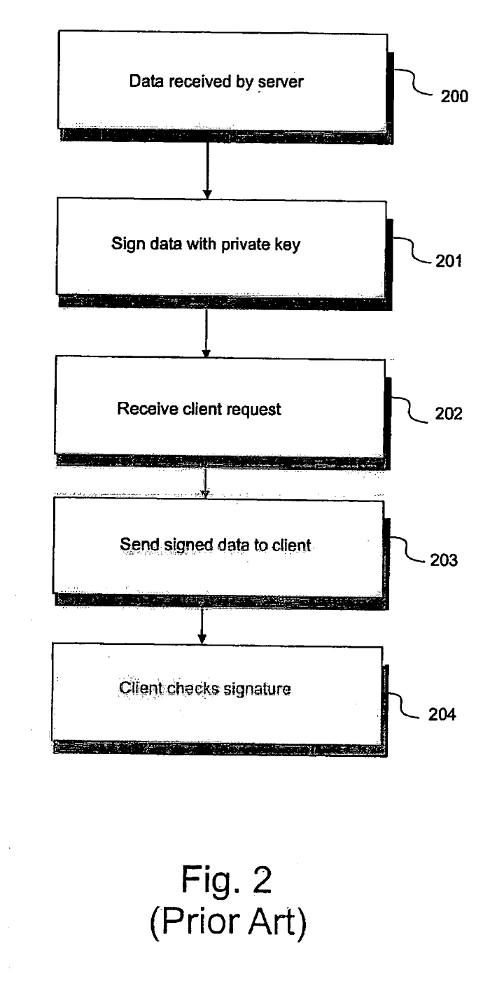

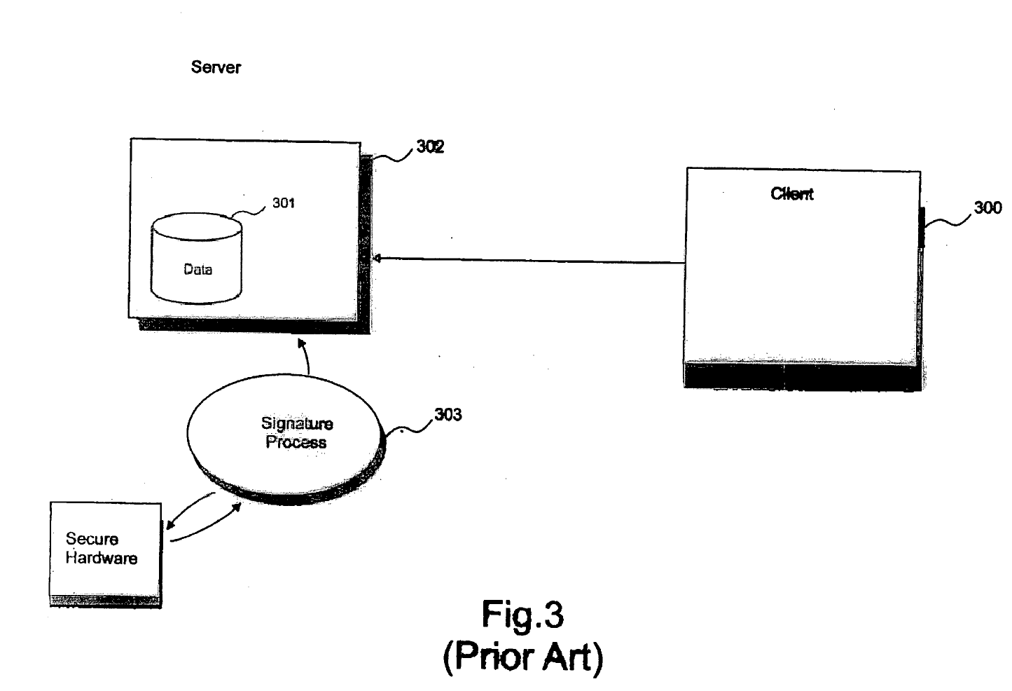

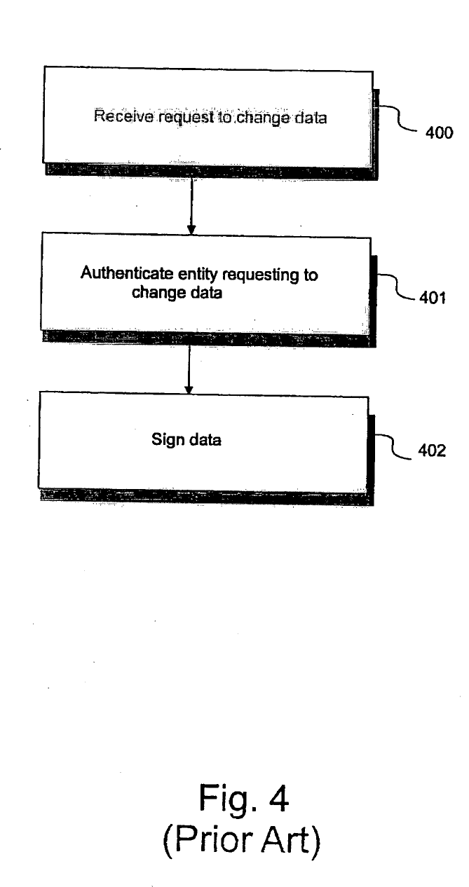

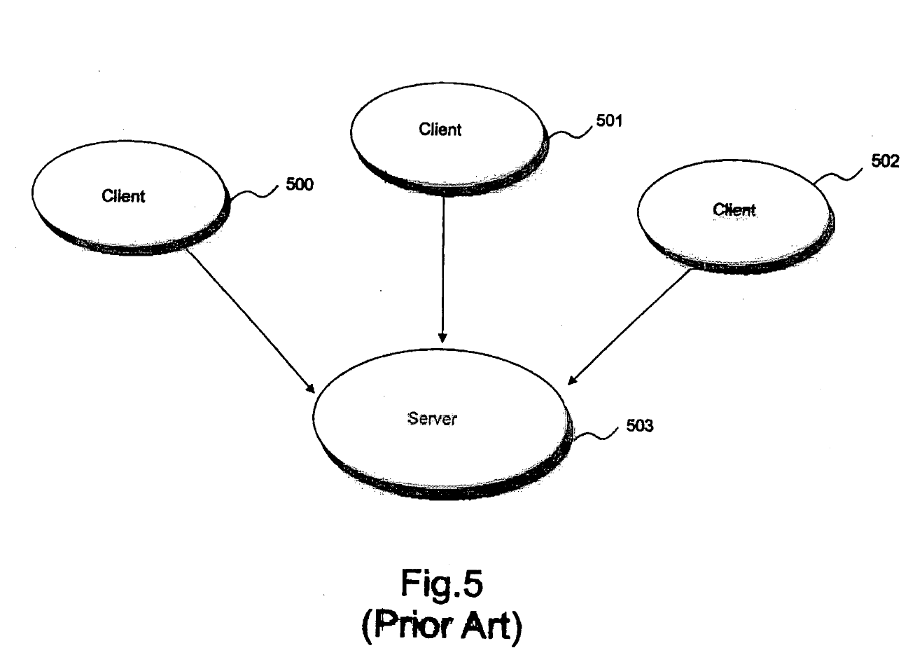

### DETAILED DESCRIPTION

There will now be described by way of example specific embodiments contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

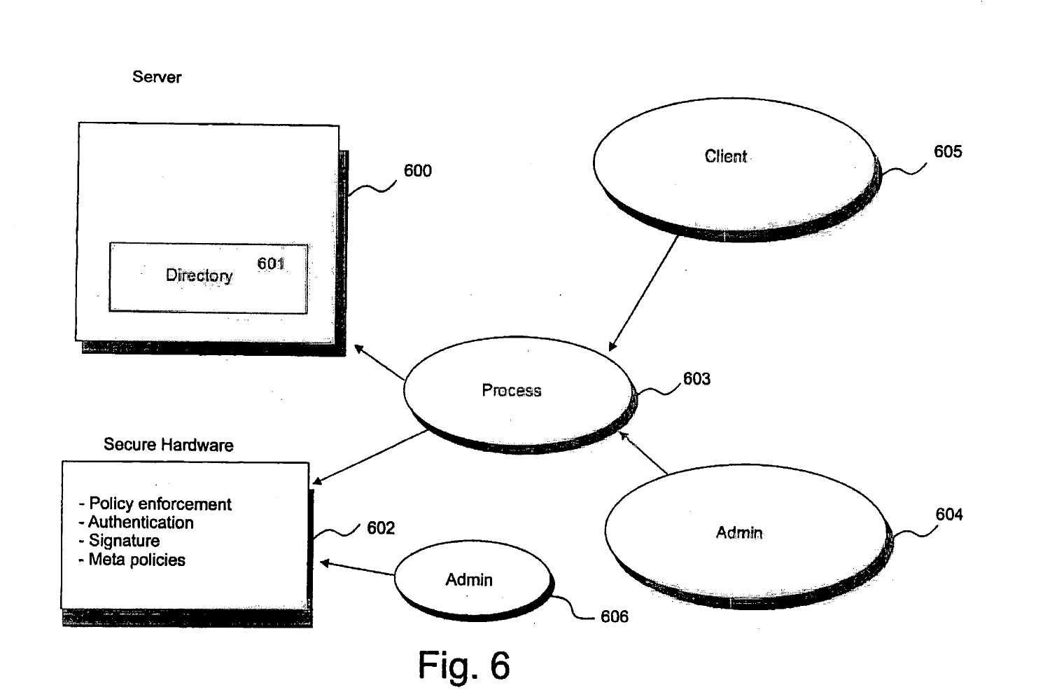

Referring to FIG. 6 herein, there is illustrated schematically a computing system, in which enforcement of policies is carried out by a secure hardware device. The system comprises a server computer entity 600 having a directory structure 601; a secure hardware device 602; and a logical functionality 603 for enabling changes to the directory structure 601; whereby the directory change functionality can be used by one or more administrators 604.

Control process 603 receives requests from one or more clients 605 to access data via directory 601. Control process 603 determines whether the client 605 has authorisation to access the requested data in the directory 601 or not. Because all the data in the directory is signed, the client can check the data and verify that the data is correct.

Secure hardware module 602 performs the functions of: controlling policy; performing authentication; and applying digital signatures to data. The processes of checking policy, and authenticating data are performed prior to signature.

The first specific embodiment herein provides a secure tamper resistant hardware device, which incorporates software which can securely store keys and invoke their usage for signing.

The secure hardware device running a service operates two distinct phases:
1. Initialization, where the device's security is checked. A public private key pair is generated and a service provider gives it a distinct PKI based identity. The PKI identity of a manager or administrator responsible is also defined at this stage.
2. Once identified, normal operations start. There are two distinct functionality's as follows:
   (a) Management—a management agent can define or change policies for what information can be changed, and can receive an appropriate signature. This signature could either use an identification of the service, or the manager could create new signing keys and certify them such that they are associated with a particular type of data. These keys may be linked with the service's identity. The manager can communicate remotely with the device and can be someone from within an alternative trusted domain, and in a different trust domain from a set of system administrators. The manager can set up a set of meta policies specifying other users who can change particular policies or pieces of policies.
   (b) Change requests—users present the data they wish to create, or present the data which they wish to change with the previous integrity check. This service has the ability to authenticate users, for example through their PKI identity, or a Kerberos ticket. The service then applies policies and will only produce an integrity check when the policies allow this. The policies can refer to authentication information including credentials, or group information, the actual authentication data being changed or created. For example, a human resources person may be able to add records, whereas a user may be able to change details in their own records. The service may demand that change requests are signed, thereby allowing it to check, for example, that a human resources person and a line manager has authorized a change. In these cases, there may be a protocol to ensure requests are fresh and recent. Policies may include types of authentication necessary, for example policies may demand human resources persons to use PKI based identity. The service may have a trust list defining who is authorized to certify which users, a nd comprises a mechanism for checking revocations of authorization. The device may appear as a service to an application, such as an LDAP (Lightweight Directory Access Protocol), which maintains control of data. Each time an application receives a request to change the data, the whole request including credentials, access policy and other parameters, is passed to the device. Only if the service is satisfied will the data be signed and returned. In this way, the change control process is moved from the domain of the application to a domain of the device. The application, for example, an LDAP server may be augmented such that it checks the integrity check with the data before providing data.

Application (LDAP) clients may wish to be augmented, and to receive and to check the integrity check data matches the data received, thus ensuring that they have a trust worthy data.

The integrity check data may simply be a signature on the data in some embodiments. However this has an issue in that it can be replayed. The integrity service may therefore issue periodically signed heartbeat checks. A client application can then check that the integrity check which they have is contained in a current heartbeat check.

In the case of an LDAP service, the integrity of LDAP information is crucial to user organizations, since it is used to hold PKI certificates, email, and organization details of such organizations. A change to a users profile could result in their email being diverted to unauthorized parties.

The first specific embodiment herein may transfer policy enforcement functionality into a secure hardware module, where policies cannot be tampered with or subverted externally to the secure hardware module.

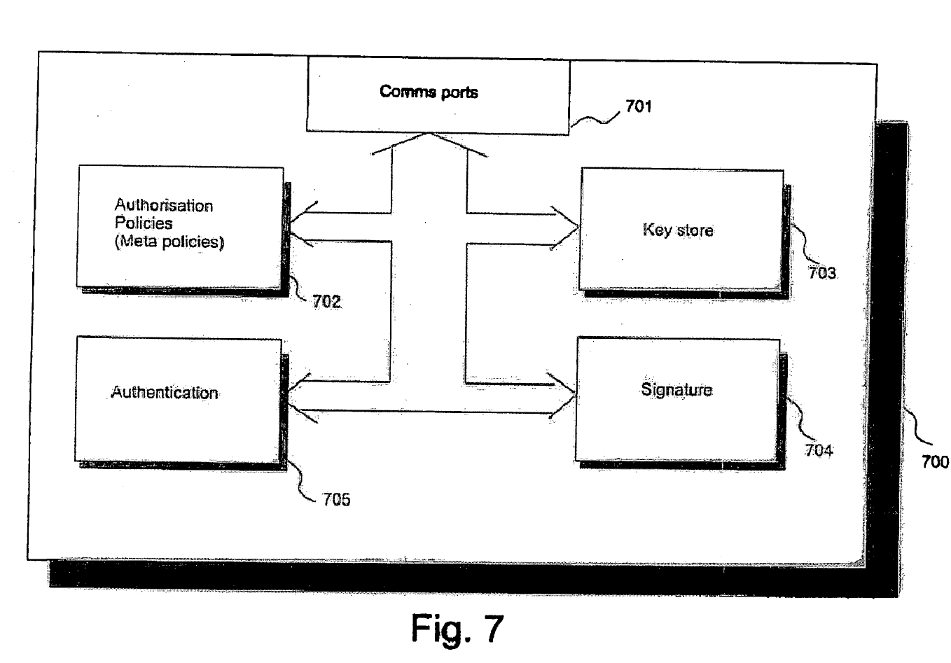

Referring to FIG. 7 herein, there is illustrated schematically components of the secure hardware module shown in FIG. 6 herein. The secure hardware module 700 comprises a communications port 701 for communicating with external entities; a policy component 702 comprising a set of authorisation policies 702 for determining whether an administrator can alter a directory structure, or data within a directory; a key store 703 comprising a set of private keys; a signature component 704 for applying signatures to data; and an authentication component 705 for authenticating data.

A first administrator 604 is an administrator who can change data in directory 601. First administrator 604 needs to authenticate himself to the secure hardware device 602 and gain authorisation, before being able to make changes to the directory data 601.

The secure hardware device 602 contains a set of meta policies which describes what policies the secure hardware device will run. The meta policies may be changed and modified by a second set of administrators 606. The meta policies 702 controlled by the second set of administrators 606 determine how the policies within the control process 603 can be changed.

An example of operation of the first specific embodiment now follows.

A first set of administrators 604 may wish to change the structure of the directory 601. For example, where an employee has left a company, and part of the directory relates to that employee, the first administrator 604 may wish to delete the part of the directory relating to the employee who has left the company.

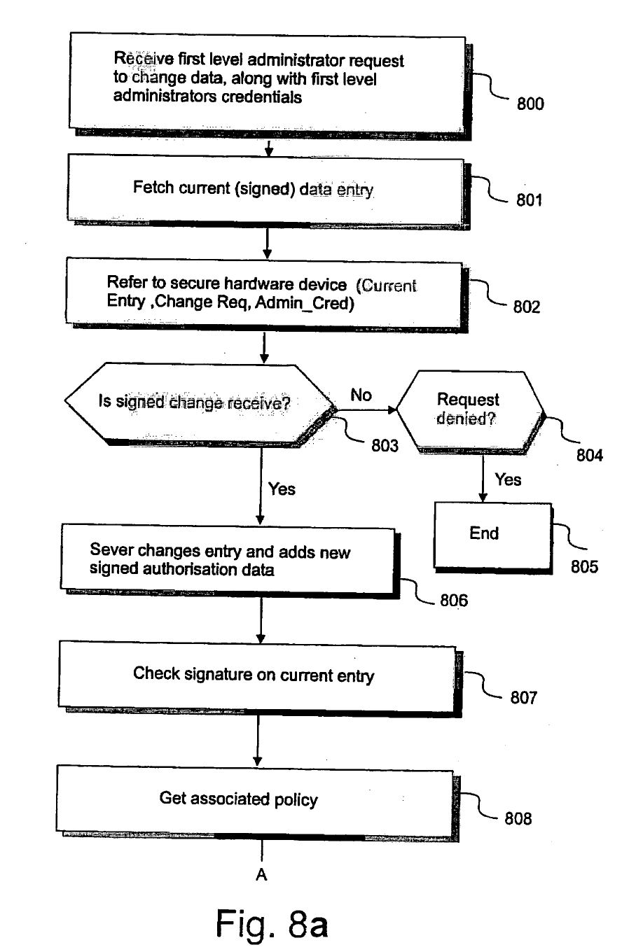

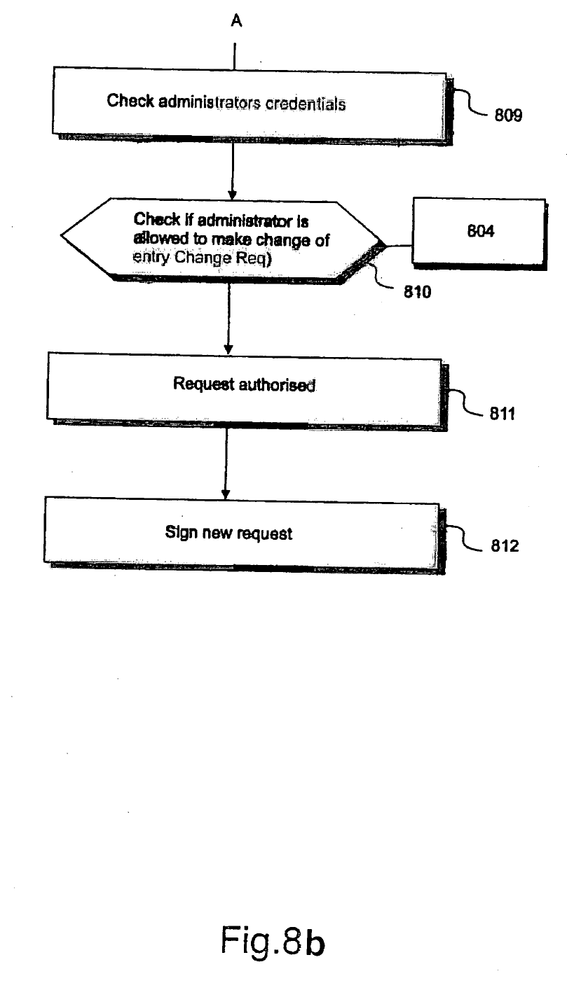

Referring to FIGS. 8a and 8b herein, there is illustrated schematically operation of the system, in which a first level administrator wishes to change data. In process 800, the process 603 receives a first level administrator request to change data, along with a set of credentials of the first level administrator. In process 603 fetches the current (signed) data entry from the server. In process 802, the current signed data entry is referred to the secure hardware device together with the request to change data, and the administrators credentials in process 803, the secure hardware device receives the signed change. If not, the request is denied in process 804, in which case the process terminates at 805. Where the signed change is received, in process 806 the server changes the entry and adds a new signed authorisation data. In process 807, the signature on the current entry is checked, and in process 808 and associated policy is fetched. The administrators credentials are checked in process 809 by the secure hardware device. If the administrator is allowed to make a change of the data entry, in process 810, then in process 811 the request is authorised and in process 812 the secure hardware device signs the new request. However, if the administrator is not allowed to make a change to the data entry, then the request is denied 804.

The control process 603 does not perform the authorisation to change the directory structure itself, but refers to the secure hardware device a request and a set of credentials of a person making the request, and depending upon whether authorisation is permitted or denied by the secure hardware device, will allow the person making the request to carry out the request or not, as appropriate.

The type of credentials presented by the administrator may be a ticket which is used in the system, the type of ticket depending upon the type normally used in the system, or may be a certificate which shows that the administrator has a private key which enables the administrator to authenticate itself to the secure hardware device.

Therefore, the secure hardware device has the information which it needs to perform authentication, and can perform authentication. The secure hardware device also needs to determine that there is a policy associated with that particular aspect of the directory which is being requested to be changed.

Therefore, the secure hardware device knows there is a policy associated with a requested aspect of the structure of the directory, the secure hardware device can check the person requesting the change against the policy for changing the directory, and once satisfied that the request is authorised to change the directory in the manner requested, the secure hardware device accesses its own private key in order to sign the request before passing it back to the control process.

The first level administrator then makes the changes to the directory, having being authorised by the secure hardware device. One or more clients 605 can then access the new directory structure 401 to read data.

The binding between the correct policy for a directory, and the directory itself is checked in the secure hardware device 602. The administrators credentials are checked and compared to the policy for changing the directory by the secure hardware device 602.

Therefore, the secure hardware device performs the operations of:
checking a binding between a directory management policy and a directory;
the authentication of the administrators; and
the enforcement of the directory management.

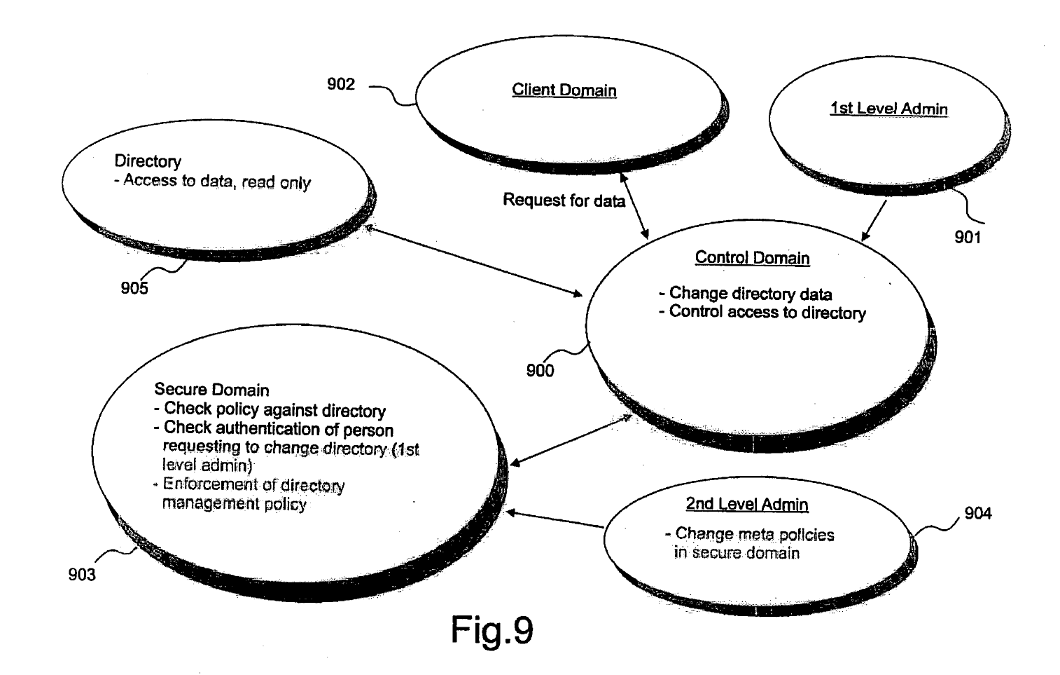

Referring to FIG. 9 herein, there is illustrated schematically a domain model of logical domains present in the system described with reference to FIGS. 6 and 7. In a control domain 900 operations of changing directory data by first level administrators 901, and operations of controlling access to directory data by clients 902 are present.

In a secure domain 903, operations of checking a policy for modifying a directory, checking authentication of a person requesting to change a directory structure, that is a first level administrator, and enforcement of directory management policies are present. A set of meta policies within the secure domain can be modified by one or more second level administrators 904.

In a directory 905, the data in the directory can be changed via the control domain, and data can be accessed by clients via the control domain.

In the specific embodiment described herein, there are a set of policies, and a set of keys, and usage of the policies is linked to the set of keys, such that both the keys and the policies are controlled within a secure hardware device, i.e. that is within a secure domain.

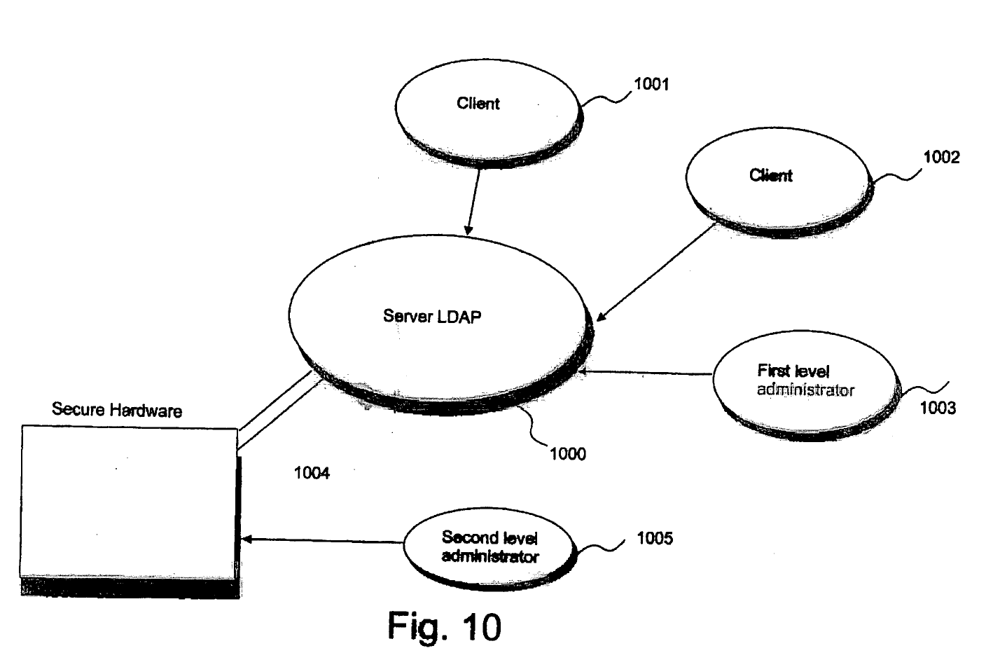

Referring to FIG. 10 herein, there is illustrated schematically the system of FIGS. 6 to 9, re-drawn. Server computer entity 1000 comprises the directory, and serves out data to a plurality of clients 1001, 1002. Clients 1001, 1002 are restricted to fetching data from the server computer 1000. A set of first level administrators 1003 have higher level permissions than the clients. In addition to fetching data, the first level administrators are capable of changing the directory structure, and changing data within the directory, subject to a set of directory management policies.

Linked to the server is a secure hardware device 1004. Whenever a first level administrator 1003 is to change any data in the directory, they must get authorisation from the secure hardware device 1004.

Clients 1001, 1002 when they fetch data, do not need to be referred to the secure hardware device. The data is already signed when it is stored in the server, and the clients can have confidence of the integrity of the data.

The secure hardware device can be used to manage changes to the overall directory management policies, in a way in which the first level administrators 1003 are controlled and restricted to making changes to the directory in accordance with those meta policies.

An example of a meta policy, in this case concerning human resources may be ‘only human resources personnel can change remuneration data for employees’. In this case, a second level administrator 1005, being at a management level higher than the human resources personnel, may change the meta policies within the secure hardware device 1004, such that the human resources personnel (the first level administrators), can change remuneration data stored in a directory of the server 1000.

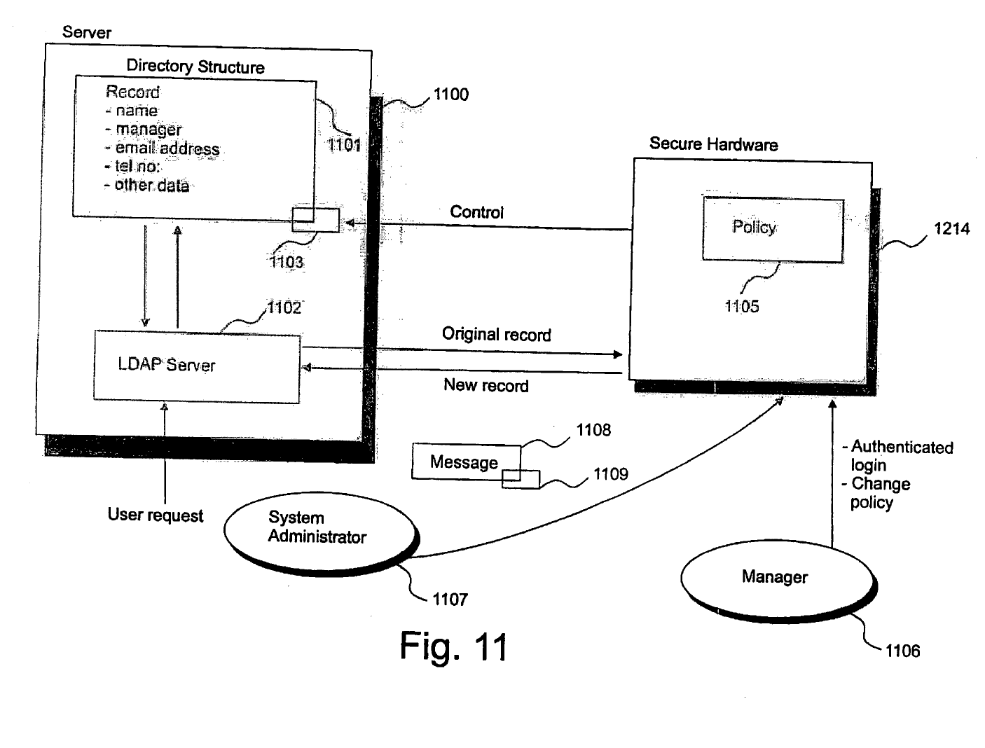

Referring to FIG. 11 herein, there is illustrated schematically a further example of a computer system according to a second specific embodiment of the present invention. In the example of FIG. 11, a server 1100 has a directory structure 1101 which stores a plurality of records. Each record has a particular form according to a template, in this example having a name field, a manager field, an email address field, a telephone number field, and one or more data fields for storing other data. Each record is created according to this record template.

Within the server 1100 is a software component, for accessing the directory, for example the Lightweight Directory Access Protocol (LDAP), the known Lightweight Directory Access Protocol (LDAP) Software 1102. The LDAP server finds a correct entry in the directory in response to a request received from a client user. In the directory, each data record is augmented by having a signature 1003.

Control of the data is effected by a secure hardware device 1104, which applies its signature to each data record within the directory. Within the secure hardware device is one or more policies 1105. Policies can be set by administrators how have access to the secure hardware device. An example of a policy may be:
a users administrator can change telephone number data;
the manager field can only be changed by a human resources personnel, and
deletion of a whole record can only be carried out by a system administrator person.

The policy data resides in the secure hardware device, and is linked to the directory structure. The data stored in the directory is the type of data which is important to keep secure, since it contains personal address details, and reflects the organisational structure of a company, therefore, it is data which needs to be controlled.

There will now be described a process for changing control of the data.

A manager 1106 wishing to change control of the data needs to authenticate herself with the secure hardware device 1104. This can be achieved by logging into the secure hardware device, for example using a Microsoft NT log in procedure, the result of which is that the secure hardware device knows the identity of the manager. Since the administrator logs in directly to the secure hardware device, the administrator is within a trusted domain, defined by the extent of the physical security, that is, a secure casing, and physical tamper proof aspects of the secure hardware device.

The secure hardware device access the record which the manager wishes to change. The LDAP server sends the current version of the record to the secure hardware device. A new record is generated by the LDAP server according to the policy 1105.

There will now be described an example of operation of the system of FIG. 11, in which a record is deleted.

Deletion of a record, according to the current policy 1105 can only be carried out by a system administrator. A system administrator 1107 sends a message 1108 which is signed with a digital signature 1109 of a person who's record is to be deleted, to the secure hardware device 1104. A policy within the secure hardware device specifies that any commands to delete an entire record must be signed with the person to which the record relates, i.e. the named employee. Alternatively, the policy 1105 may specify that in order to delete a record, two signatures are required, for example a signature of a system administrator, and a signature of the person whose record is being deleted. The LDAP server checks the integrity of the overall file system, and also checks the integrity of each individual data record.

The above examples illustrate how various levels of authorisation and authentication may be required within the system, and the system can handle changes to data which can be carried out by almost any person, or alternatively can handle changes to data which require several levels of authentication and several signatures from different authorised persons.

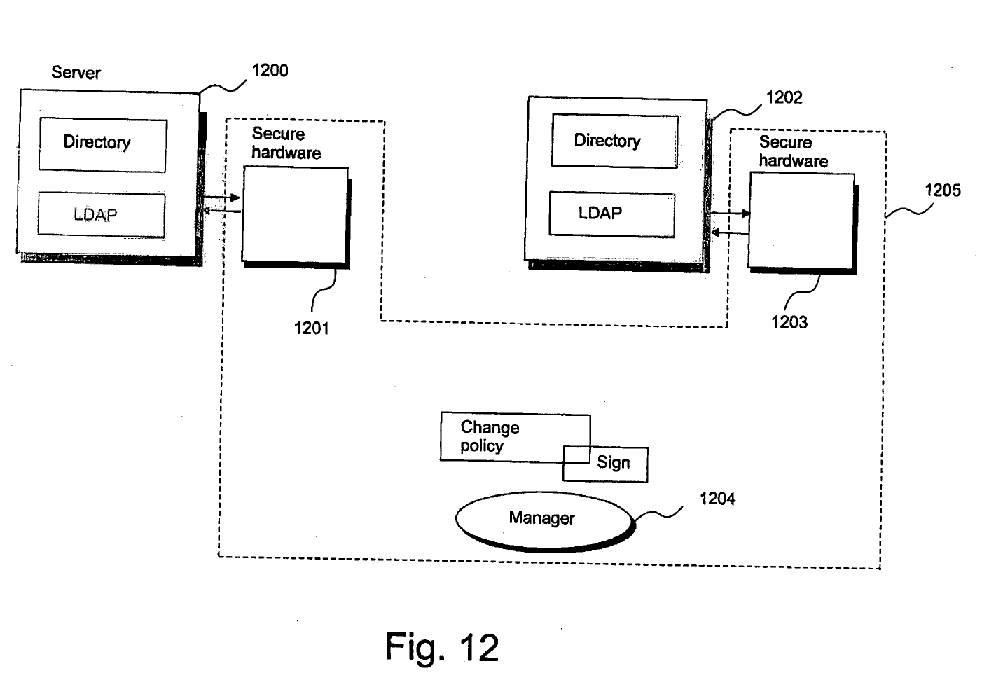

Referring to FIG. 12 herein, there is illustrated schematically the system of FIG. 11, replicated, such that a first server 1200 and first secure hardware device 1201 may be duplicated at a separate location as a second server 1102, and second secure hardware device 1203. Policies may be changed centrally by an authorised person operating within a trusted domain, in which the trusted domain comprises a domain of the first and second secure hardware devices 1201, 1203.

A manager 1204 may send a change policy message to each of the secure hardware devices, where the change policy message is signed, and contains details of changes to policies stored in each of the secure hardware devices. In this way, a top level policy change can be applied globally by a manager or other administrator within a trusted domain, by changing policy data within each of a plurality of secure hardware devices, where the policy data controls one or more servers and the policy data controls how access to data stored within those servers can be made by other users, for example, clients or lower level administrators.

The trusted domain 1205 is protected from external attacks, or by attacks from lower level administrators in the system, by virtue of the physical security of each secure hardware device, these being provided with tamper proof casings, and by a set of identities stored within the secure hardware devices, which can be used to authenticate messages sent by a manager 1204 within the trust domain.

Whilst specific embodiments herein have been described using an LDAP software for accessing a directory, the invention is not limited to using the known LDAP software.

The specific embodiments described herein may have general applicability to data stores where clients or requesters require strong guarantees of the integrity of data items which they retrieve. However, the specific implementations described herein are particularly suited to directory type services, where particular requests are to read data and fewer requests are for changing data.

Large enterprises have large information technology departments devoted to ensuring separation of concerns amongst the administrators which configure the LDAP servers, so can achieve good integrity. The specific embodiments described herein may significantly reduce the cost and complexity of securely managing such service. Additionally, the specific embodiments disclosed herein may also make it feasible for much smaller companies to run LDAP servers to a security standard required for their businesses.

1. A method of applying policy enforcement in a computing system, said method comprising:
applying an authorisation policy within a secure hardware domain; and
applying a digital signature within said secure hardware domain.

2. The method as claimed in claim 1, wherein said authorization policy comprises a policy for determining access rights to data stored outside said secure hardware domain.

3. The method as claimed in claim 1, wherein said authorization policy comprises a policy for determining which persons can modify access rights to a directory structure.

4. The method as claimed in claim 1, comprising:
verifying an identity of a user authorized for changing said authorization policies within said secure hardware domain; and
in response to a command from said authorized user, amending a said authorization policy within said secure hardware domain.

5. A secure hardware device comprising:
a digital signature component for applying a digital signature to an item of data; and
a policy enforcement component for applying an access control policy to said item of data.

6. The secure hardware device as claimed in claim 5, further comprising:
an authentication component for authenticating a user requesting to amend said item of data.

7. The secure hardware device as claimed in claim 5, further comprising:
an authentication component for authenticating a user requesting to amend a policy data stored within said secure hardware device.

8. A computer system comprising:
a server computer having a data storage device, which stores data in a file system;
a control component capable of controlling access to said file system; and
a secure hardware device, said secure hardware device configured for controlling changes to said file system made by at least one administrator person via said control component.

9. The computer system as claimed in claim 8, wherein said secure hardware device is configured for checking authorization of a user requesting to change a directory of said file system.

10. The computer system as claimed in claim 8, wherein said secure hardware device is configured for checking authorization of a user requesting to change said data.

11. A method of controlling changes to a file system, comprising:
receiving a request for making a change to said file system;
receiving a set of credentials of a person making said request to change said file system;
authenticating said credentials of said person, in a secure hardware device;
verifying that said request to change said file system conforms with a management policy for managing said file system; and
if said request conforms with said management policy, and said person is authenticated, then allowing said person to change said file system.

12. A secure hardware device, comprising:
a tamper proof casing; and
a policy component, capable of storing a set of policies;
wherein said policy component is accessible by at least one person, who is authorized to change said policies; and
said set of policies control access to data stored externally of said secure hardware device.

13. The secure hardware device as claimed in claim 12, further comprising:
an authorization component, said authorization component capable of authorizing a said at least one person for changing said policies.

14. The secure hardware device as claimed in claim 12, further comprising:
an authorization component, said authorization component capable of authorizing a said at least one person for changing said policies, said authorization component comprising a digital signature storage component for storing digital signatures of persons authorized to change said policies.

15. A system of computer entities configured into a plurality of domains comprising:
a client domain in which client users can access data;
a first level domain in which users of said first level domain have permission is to modify said data; and
a second level domain in which users of said second level domain are permitted to set policies concerning the modification of data applicable in said first level domain.

16. The computer system as claimed in claim 15, wherein;
in said client domain, items of said data are certified by a digital signature.

17. The computer system as claimed in claim 15, wherein in said first level domain, said users of said first level domain are authenticated by functionality within said second level domain.

18. The computer system as claimed in claim 15, wherein a set of meta policies resident in said second level domain controls permissions of said users in said first level domain.

19. A method of operation of a system of computer entities, said method comprising:
organizing said system of computer entities into;
a client domain in which client users can access data;
a first level domain in which users of said first level domain have permission to modify said data; and
a second level domain in which users of said second level domain are permitted to set policies concerning the modification of data carried out in said first level domain.

20. The method as claimed in claim 19, further comprising:
certifying items of data of said client domain, said certification being performed in said second level domain.

21. The method as claimed in claim 19, further comprising:
authenticating within said second level domain said users of said first level domain.

22. The method as claimed in claim 19, further comprising:
controlling permissions of said users of said first level domain, according to a set of policies resident within said second level domain.
